(19) United States
(12) Patent Application Publication
(10) Pub. No.: US 2023/0229966 A1
(43) Pub. Date: Jul. 20, 2023

(54) DEEP LEARNING BASED ARRIVAL TIME PREDICTION SYSTEM

(71) Applicant: Uber Technologies, Inc., San Francisco, CA (US)

(72) Inventors: Fahrettin Olcay Cirit, San Francisco, CA (US); Xinyu Hu, Santa Clara, CA (US); Eric Frank, San Franciso, CA (US)

(21) Appl. No.: 18/099,328

(22) Filed: Jan. 20, 2023

Related U.S. Application Data
(60) Provisional application No. 63/301,358, filed on Jan. 20, 2022.

(51) Int. Cl. G06N 20/00; G01C 21/34

(52) U.S. Cl. CPC G06N 20/00; G01C 21/3438; G01C 21/3446

(57) ABSTRACT

An estimated time of arrival (ETA) of a vehicle is predicted by receiving a request for the vehicle to conduct a trip that includes a first location. A predicted ETA for the vehicle to travel from a particular location to the first location is computed. The predicted ETA is refined to compute a refined ETA using a machine-learned model that takes as input a plurality of features associated with the trip. The plurality of features including at least geospatial features transformed using a locality-sensitive hashing function. An action is performed based on the refined ETA. The action may include one or more of estimating a pickup time or drop-off time for the trip, matching a driver to the trip, and planning a delivery.

### CROSS REFERENCE TO RELATED APPLICATIONS

The application claims the benefit of provisional patent application 63/301,358, filed on Jan. 20, 2022, which is herein incorporated by reference in its entirety.

### FIELD OF ART

The present invention generally relates to the field of travel time estimation using artificial intelligence, and more specifically, to deep learning-based prediction of arrival time of a vehicle.

### BACKGROUND

Conventional techniques for computing estimated time of arrival (e.g., ETAs, arrival times, and the like) involve dividing up a road network into small road segments represented by weighted edges in a graph. Such conventional techniques use shortest-path algorithms to find the best path through the graph and add up the weights to derive an ETA. However, a map is not the terrain. A road graph is just a model, and it cannot perfectly capture conditions on the ground. Moreover, a particular driver (e.g., rideshare driver, courier) may choose a route that is different from the one recommended by the shortest-path algorithm, thereby resulting in constant re-routing and changes to the ETA.

### SUMMARY

In some embodiments, a computer-implemented method for predicting an estimated time of arrival (ETA) of a vehicle is provided comprising a plurality of steps. The steps include a step of receiving a request for the vehicle to conduct a trip that includes a first location. The steps further include a step of computing a predicted ETA for the vehicle to travel from a particular location to the first location. The steps further include a step of refining the predicted ETA to compute a refined ETA using a machine-learned model that takes as input a plurality of features associated with the trip, the plurality of features including at least geospatial features transformed using a locality-sensitive hashing function. And the steps further include a step of performing an action based on the refined ETA.

### BRIEF DESCRIPTION OF DRAWINGS

FIG. 1 illustrates a system environment for predicting and refining ETAs, in accordance with some embodiments.

FIG. 2 is an illustration of the difference between the predicted ETA computed by the routing engine of FIG. 1 and the refined ETA computed using the machine-learned model of FIG. 1, in accordance with some embodiments.

FIG. 3 is a high-level block diagram of the machine-learned model of FIG. 1, in accordance with some embodiments.

FIG. 4 is a process diagram of the embedding layer of the machine-learned model, in accordance with some embodiments.

FIG. 5 is an illustration of multi-resolution geohashes with multiple feature hashing using independent hash functions, in accordance with some embodiments.

FIG. 6 is an illustration of the sequence-to-sequence operation performed using the attention matrix of the linear self-attention layer of the machine-learned model, in accordance with some embodiments.

FIG. 7 is an illustration of the bias adjustment operation performed by the calibration layer of the machine-learned model, in accordance with some embodiments.

FIG. 8 is a flowchart illustrating the process for refining predicted ETAs using the machine-learned model, in accordance with some embodiments.

FIG. 9 is a block diagram illustrating components of an example computing machine, in accordance with some embodiments.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Configuration Overview

Techniques disclosed herein look to predict accurate ETAs by implementing a machine-learned model (e.g., post-processing model) that provides flexible application to different sub-domains or scenarios of transportation while also providing both high degrees of accuracy and low degrees of latency when producing ETAs. The model corrects (e.g., refines, adjusts) the ETAs produced by a shortest path graph-based routing algorithm to better account for observed real-world outcomes, such as the decisions made by different drivers. Employing the post-processing model to correct an ETA predicted by the graph-based routing algorithm provides better modularity and avoids the need to refactor the routing algorithm as new data is obtained. The model considers spatial and temporal features, such as the origin, destination, and time of the request, as well as real-time traffic data and calibration features (e.g., type features) such as the nature of the request, such as whether it is a delivery drop-off or rideshare pickup.

In various embodiments, to achieve accuracy and speed for predicted ETA correction, the machine-learned model may leverage feature sparsity through use of embedding lookup tables, which have constant lookup time, rather than the logarithmic or quadratic lookup time of other data structures. Further, the model may use a transformer architecture with self-attention in which each vector represents a single feature. Categorical features are embedded, and continuous features bucketized before embedding. Geospatial features receive specialized embeddings using multiple different resolution grids. In some embodiments, a linear self-attention layer of the machine-learned model may employ a linear transformation to avoid quadratic time of calculating an attention matrix. The machine-learned model may further be generalized and made applicable to different transportation scenarios through the use of a bias adjustment layer (e.g., calibration layer). Asymmetric Huber Loss, with parameters controlling the degree of robustness to outliers and the degree of asymmetry, may further allow the model to adjust to different scenarios.

At serving time, the server may receive (via an API and from an ETA consumer) a request for a vehicle to conduct a trip from a given origin (e.g., begin location) to a given destination (e.g., end location). The routing engine may compute a predicted ETA for a vehicle to travel from the given origin to the given destination. The predicted ETA output from the routing engine along with features (e.g., geospatial features, temporal features, continuous features, categorical features, calibration or type features, and the like) and other data (e.g., real-time traffic data, map data) associated with the trip (received, e.g., from the ETA consumer) may be input to the machine-learned model. The machine-learned model may compute a refined ETA by correcting (e.g., adjusting, refining) the predicted ETA to derive a more accurate estimate that better reflects real-world factors not accounted for by the graph-based routing engine. The server may use the refined ETA in a number of calculations, such as calculating fares, estimating pickup or delivery times, matching riders to drivers, matching couriers to restaurants, and the like. The design of the machine-learned model and its use in conjunction with the predicted ETA output from the routing engine allows the processing of large-scale requests with very low latency. For example, billions of requests may be processed each week, with only a few milliseconds of processing time per request.

### System Environment

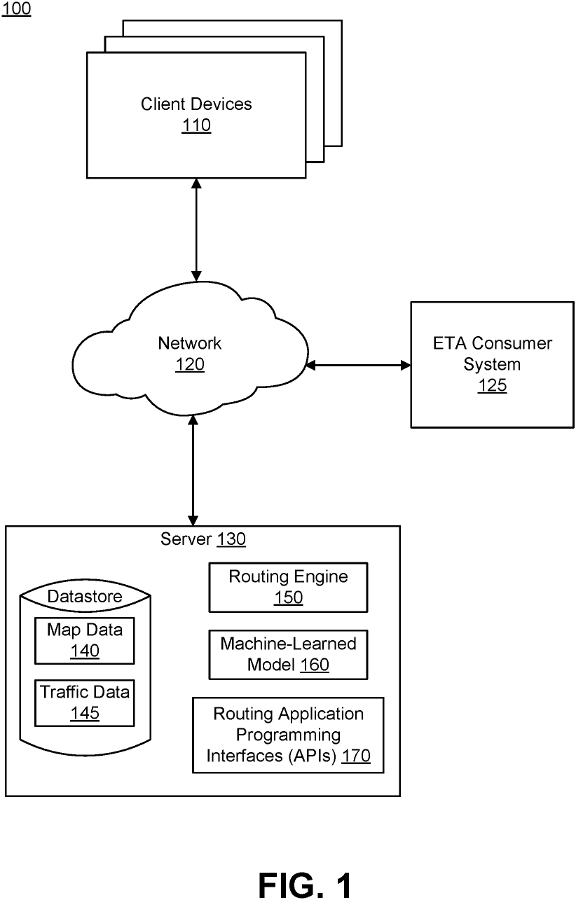

FIG. 1 illustrates a system environment 100 for predicting ETAs, according to some embodiments. The system environment, or system, includes one or more client devices 110, network 120, ETA consumer system 125, and server 130. FIG. 1 shows one possible configuration of the system. In other embodiments, there may be more or fewer systems or components, for example, there may be multiple servers 100 or the server 100 may be composed of multiple systems such as individual servers or load balancers or functionality of the ETA consumer system 125 may be subsumed by the server 100. These various components are now described in additional detail.

Each client device 110 is a computing device such as a smart phone, laptop computer, desktop computer, or any other device that can access the network 120 and, subsequently, the server 130.

The network 120 may be any suitable communications network for data transmission. In an embodiment such as that illustrated in FIG. 1, the network 120 uses standard communications technologies and/or protocols and can include the Internet. In another embodiment, the entities use custom and/or dedicated data communications technologies. The network 120 connects the client device 110, the ETA consumer system 125, and the server 130 to each other.

The ETA consumer system 125 may include one or more ETA consumers that transmit requests (and associated data) for ETA from the machine-learned model 160 on the server 130. For example, the ETA consumers may correspond to a ride-sharing system, a food delivery system, a fare calculation system, a system for matching riders to drivers, and the like.

The server 100 includes datastore 135, a routing engine 150, a machine-learned model 160, and one or more routing application programming interfaces (APIs) 170. The datastore 135 may include map data 140 and traffic data 145.

As explained previously, the server 130 may power billions of transactions that depend on accurate arrival time predictions (ETAs). For example, the ETAs may be used to calculate fares, estimate pickup and dropoff times, match riders to drivers, match couriers to restaurants, and the like, by the ETA consumer system 125. Due to the sheer volume of decisions informed by ETAs, reducing ETA error by even low single digit percentages unlocks tens of millions of dollars in value per year by increasing marketplace efficiency.

The server 130 may implement the routing engine 150 (e.g., route planner) to predict ETAs. The routing engine 150 may be a graph-based model that operates by dividing up the road network into small road segments represented by weighted edges in a graph. The routing engine 150 may use shortest-path algorithms to find the best path from origin to destination based on the map data 140 and add up the weights to obtain the predicted ETA. In some embodiments, the routing engine 150 may also consider the traffic data 145 (e.g., real-time traffic patterns, accident data, weather data, etc.) when estimating the time to traverse each road segment. That is, based on the map data 140 and traffic data 145, the graph-based routing engine identifies the best path between a particular location (e.g., begin location or current location of a vehicle) and the end location (e.g., destination received from a client device requesting a ride), and computes the predicted ETA as a sum of segment-wise traversal times along the best path.

However, the predicted ETA calculated by the routing engine 150 may be inaccurate for several reasons. That is, the graph-based models used by the routing engine 150 can be incomplete with respect to real world planning scenarios typically encountered in ride-hailing and delivery. One problem with the predicted ETA calculated by the routing engine 150 is route uncertainty. That is, the routing engine 150 does not know in advance which route a driver or courier will choose to take to their destination. This uncertainty will lead to an inaccurate ETA prediction if the (shortest or best-path) route assumed by the routing engine 150 based on the map data 140 and the traffic data 145 differs from the actual route taken by the driver.

Another problem with the predicted ETA calculated by the routing engine 150 is human error. That is, human drivers may make mistakes especially in difficult sections of the road network, but shortest-path algorithm of the routing engine 150 may not account for this when calculating the predicted ETA. Yet another problem with the predicted ETA calculated by the routing engine 150 is distribution Shift, which refers to the empirical arrival time distributions differing markedly across different tasks, such as driving to a restaurant or driving to pick up a rider, even when the shortest path is the same. Yet another problem with the predicted ETA calculated by the routing engine 150 is uncertainty estimation. Different ETA use cases call for distinct point estimates of the predictive distribution. For example, fare estimation requires a mean ETA, whereas user facing ETAs may call for a set of ETA quantiles or expectiles.

To overcome the above problems, the ETA estimation according to the present disclosure includes the machine-learned model 160 to refine (e.g., correct, adjust) the predicted ETA computed by the routing engine 150, by computing a residual and using the predicted ETA and the residual to compute a refined ETA. The machine-learned model 160 may use observational data to produce ETAs better aligned with desired metrics and real-world outcomes. Conventional machine learning based approaches to ETA prediction for ride hailing and food delivery assume that the route will be fixed in advance, or they combine route recommendation with ETA prediction. Both past approaches solve simplified versions of the ETA prediction problem by making assumptions about the route taken or the type of task.

The machine-learned model 160 (e.g., ETA post-processing model) according to the present disclosure implements a hybrid approach that treats the routing engine 150 ETA as a noisy estimate of the true arrival time. In some embodiments, the machine-learned model 160 may be a deep learning-based model to predict the difference between the routing engine 150 ETA and the observed arrival time. As shown in FIG. 1, the routing APIs 170 may receive an ETA request from an ETA consumer on the ETA consumer system 125. For example, the request may be based on a user request for a vehicle to conduct a trip that includes a first location (e.g., end location of a trip). The routing APIs 170 may also receive corresponding feature data for the trip from the ETA consumer system 125. Based on the request, the routing engine 150 with access to map data 140 and real-time traffic data 145 may compute the predicted ETA for the vehicle to travel from a particular location (e.g., current location or begin location) to the first location.

The machine-learned model 160 refines the routing engine 150 predicted ETA to compute a refined ETA. The machine-learned model 160 takes as input the features corresponding to the trip as received by the routing APIs 170 from the ETA consumer system 125. Such an approach may outperform both the unaided routing engine 150 ETAs as well as other baseline regression models. Further, the machine-learned model 160 can be implemented on top of a graph-based output (e.g., output of the routing engine 150) as a post-processing operation. The machine-learned model 160 is operable in low-latency, and high-throughput deployment scenarios.

The refined ETA computed based on the output of the machine-learned model 160 may be transmitted to the ETA consumer system 125 via the corresponding routing API 170. The ETA consumer system 125 may then perform one or more actions based on the computed refined ETA. For example, the one or more actions may include estimating a pickup time for the trip, estimating a drop-off time for the trip, matching a driver to a trip request, planning a delivery, and the like.

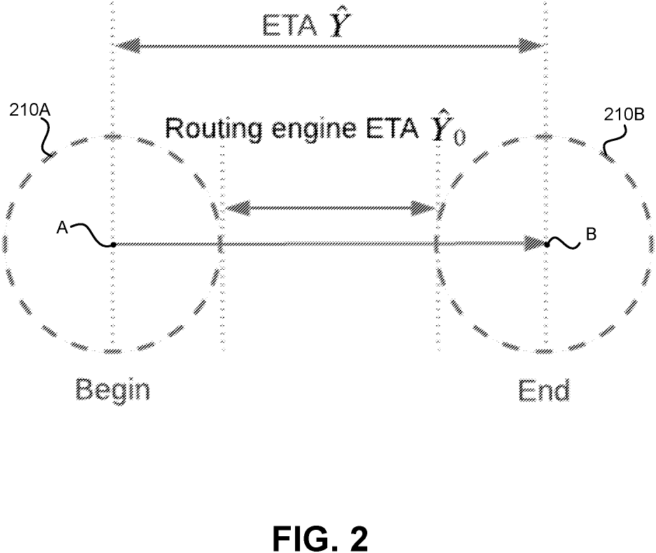

The difference between the predicted ETA computed by the routing engine 150 and the refined ETA computed based on an output of the machine-learned model 160 is described in further detail below with reference to FIG. 2. The ETA prediction task is defined as predicting the travel time from point A to point B in FIG. 2. The travel path between A to B is not fixed as it may depend on the real-time traffic condition and what routes drivers or couriers choose. ETA prediction is formulated as a regression problem. The label is the actual arrival time (ATA), which is a continuous positive variable, denoted as Y ∈ R⁺. The ATA definition varies by the request type, which could be a pick-up or a drop-off. For a pick-up request, the ATA is the time taken from driver accepting the request to beginning the ride or delivery trip. For a drop-off request, the ATA is measured from the begin of the trip to the end of the trip.

The predicted ETA from the routing engine 150 is referred to as the routing engine ETA (RE-ETA), denoted as Y₀ ∈ R⁺. For each ETA request qi = { τi, pi, xi }, where τi is the timestamp, pi = {pi1, pi2, ..., pim} is the recommended route segments from the routing engine and xi is the features at timestamp τi, for i = 1, ..., n. The task of the machine-learned model 160 is to learn a function g that maps the features to predict an ATA. The ETA is denoted as Ŷ:

$$G \left({q}_{i}\right) \to {\hat{y}}_{i} .$$

The recommended route from the routing engine 150 is represented as a sequence of road segments ρᵢ. The RE-ETA from the routing engine 150 is calculated by summing up traversal time of the road segments

$${\hat{y}}_{0 i} = {\sum }_{j = 1}^{m} {t}_{p i j} ,$$

where tₚᵢⱼ denotes the traversal time of the jth road segment ρᵢⱼ for the ith ETA request. The quality of ŷ₀ᵢ depends on the estimated road segments tₚᵢⱼ. In real world situations, drivers may not always follow the recommended route, resulting in re-routes. Therefore ŷ₀ᵢ may not be an accurate estimation of ATA.

The begin and end location neighborhoods 210A and 210B of a request account for a large proportion of noise. For instance, the driver may have to spend time in looking for a parking spot. As shown in FIG. 2, the RE-ETA circumvents this uncertainty by estimating the travel time between the neighborhoods 210A and 210B instead of the actual begin and end locations. FIG. 2 also illustrates the difference between the RE-ETA output from the routing engine 150 and the final ETA. To accommodate the difference between ETA ŷ and RE-ETA ŷ₀ᵢ, the system includes the post-processing model 160 to process the ŷ₀ᵢ for more accurate ETA predictions,

$$G \left({q}_{i} , {\hat{y}}_{0}\right) \to {\hat{y}}_{i} .$$

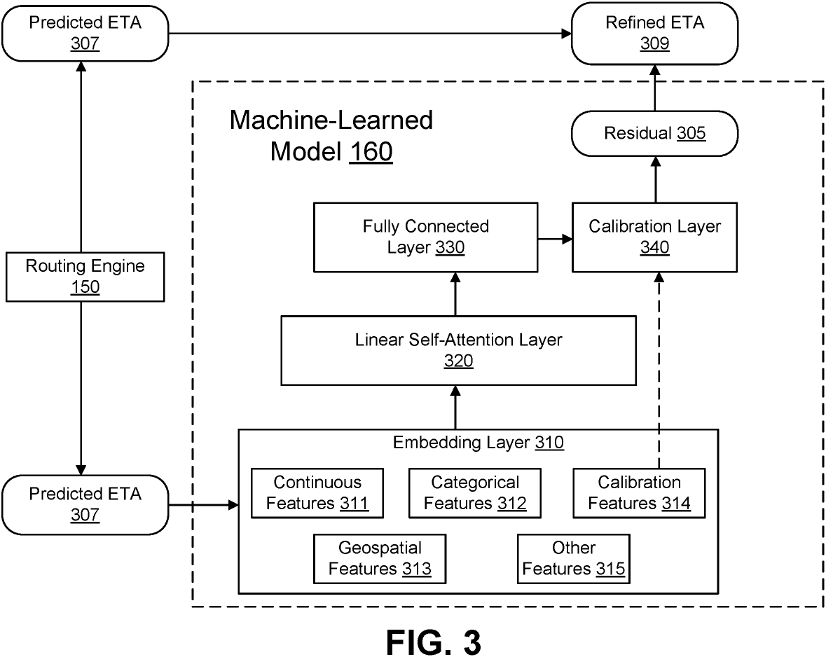

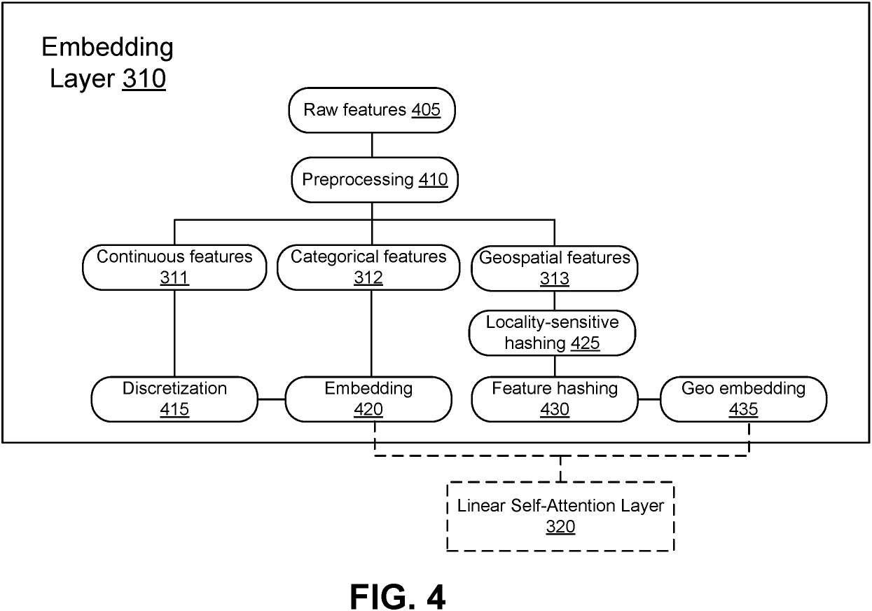

For an ETA request qᵢ, Xᵢ ∈ R^{ρ} denotes a p-dimensional feature vector. Xᵢ includes the features associated with the trip and received in each ping. The different features associated with the trip (e.g., received from the ETA consumer as part of the ETA request) are described in detail below in connection with FIGS. 3 and 4.

### Machine-Learned Model

FIG. 3 is a high-level block diagram of the machine-learned model 160 of FIG. 1, in accordance with some embodiments. In some embodiments, the machine-learned model 160 is a self-attention-based deep learning model that is trained to predict the ATA by estimating a residual 305 that is added to the predicted ETA 307 output from the routing engine 150. That is, the machine-learned model 160 is used to compute the refined ETA 309 by adding the residual 305 that is output from the machine-learned model 160 to the predicted ETA 307 computed using the graph-based routing engine 150. The model 160 may further implement a function such as using ReLU(▪) = max(0,▪), at output to force the refined ETA 309 to be positive. The residual r̂ᵢ is a function of (qᵢ, ŷ₀ᵢ) to correct the RE-ETA 307,

$${\hat{y}}_{i} = {\hat{y}}_{0 i} + {\hat{r}}_{i} .$$

As shown in FIG. 3, the machine-learned model 160 includes an embedding layer 310, a linear self-attention layer 320, a fully connected layer 330, and a calibration layer 340. The model may include more than one instance of each of the layers. In some embodiments, the machine-learned model 160 has a shallow configuration with few layers, and the vast majority of the features exist in embedding lookup tables. By discretizing the inputs and mapping them to embeddings, the model 160 avoids evaluating any the unused embedding table parameters. The embedding layer 310 takes in the predicted ETA 307 output from the routing engine 150 and features associated with the ETA request to generate embeddings for the different features. The features may be categorized into different categories. For example, the features may be categorized into continuous features 311, categorical features 312, geospatial features 313, calibration features 314, and other features 315.

The continuous features 311 may include traffic features like real-time speed, historical speed, and the like. The categorical features 312 may include temporal features like minute of day, day of week, and the like. The categorical features 312 may also include context features (e.g., context information) like country ID, region ID, city ID, and the like. The geospatial features 313 may include latitude and longitude of the begin location, latitude and longitude of the end location, and the like. The calibration features 314 may include type features like trip type, route type, request type, etc. The features encoded by the embedding layer 310 may also include other features 315 like the predicted ETA 307 computed by the routing engine 150, estimated distances, etc. In some embodiments, the features input to the model 160 and encoded by the embedding layer 310 may only include spatial and temporal features including the origin, the destination, the time of the request, real-time traffic data, the nature of the request (e.g., food delivery drop-off, ride-hailing pick-up, etc.), as well as the predicted ETA 307.

The embedding layer 310 aims to encode the features into embeddings. The linear self-attention layer 320 aims to learn the interaction of geospatial and temporal embeddings, and the fully connected layer 330 and calibration layer 340 aim to adjust bias from various request types (e.g., based on the calibration features 314). Each layer of the machine-learned model 160 is described in further detail below.

### Embedding Layer

FIG. 4 is a high-level process diagram of operations performed at the embedding layer 310 of the machine-learned model 160, in accordance with some embodiments.

The embedding layer 310 performs feature encoding for the different categories of features. Raw features 405 may be received in each ping (e.g., each ETA request from the system 125) and may include one or more of the continuous features 311, the categorical features 312, the geospatial features 313, the calibration features 314, and the other features 315. For example, the raw features 405 received in each ping may include minute of day, day of week, begin location end location, real-time speed, horizontal speed, and the like. The raw features 405 may be preprocessed 410 into discrete bins prior to the embedding layer 310 learning the hidden representation of each bin. Processing performed to learn the hidden representations may depend on the category of the features, as described in further detail below.

The embedding layer 310 may map the continuous features 311 and the categorical features 312 to embeddings 420. For example, in a dataset with n instances, each has a feature vector xᵢ, and it contains p dimensional features Xᵢ = [xᵢ₁, xᵢ₂, ^{...}, xᵢₚ]. For the continuous features 311 (e.g., real-time speed, historical speed, etc.), the embedding layer 310 may first perform a discretization (e.g., quantization, bucketization) 415 operation to discretize the continuous features into buckets, thereby transforming the continuous features into discrete or categorical features, and then mapping the discretized continuous features to embeddings 420 using the buckets for embedding look-up. The embedding look-up for a continuous feature x_{β} can be written as

$${e}_{β} = {E}_{β} \left[Q \left({x}_{β}\right)\right] ,$$

where Q(▪) is the quantile bucketizing function and E_{β} ∈ R^{v}β^{×d} is the embedding matrix with ν_{β} buckets after discretization 415. For example, speed is bucketized into 256 quantiles, which may lead to better accuracy than using them directly as continuous features for the other layers of the machine-learned model 160. Further, in some embodiments, quantile buckets may be used since they may provide better accuracy than equal-width buckets.

For the categorical (e.g., discrete) features 312 (e.g., temporal features), the embedding layer 310 may obtain the embedding 420 of a categorical feature x_{α} by the embedding look-up operation:

$${e}_{α} = {E}_{α} \left[{x}_{α}\right] ,$$

where E_{α} ∈ R^{ν} a^{×d} is the embedding matrix for the αth feature, the vocabulary size is ν_{α} and embedding size is d. E_{α}[▪] denotes look-up operation. For example, minute of week is embedded with the vocabulary size equals to 10080 and embedding size 8.

For the geospatial features 313, the embedding layer 310 uses a locality-sensitive hashing function 425 and feature hashing 430 to transform the geospatial features 313 into geo embeddings 435. That is, the embedding layer 310 transforms the geospatial features 313, like longitudes and latitudes of begin and end locations, using locality-sensitive hashing 425 and multiple feature hashing 430. The locality-sensitive hashing function hashes locations into buckets based on similarity. In some embodiments, the locality-sensitive hashing function is a geohash function. In other embodiments, other locality-sensitive hashing functions including those that use information beyond the origin and destination may be employed for transforming the geospatial features 313 into geo embeddings 435.

For example, geohashing may be performed to obtain a unique string to represent the 2D geospatial information and then feature hashing 430 is performed to map the string to a unique index for geo embedding look-ups 435. Therefore, the embedding for a pair of longitude and latitude xk can be obtained by

$${e}_{k} = {E}_{k} \left[H \left({x}_{k}\right)\right] ,$$

where H(▪) is introduced in below in connection with feature hashing 430.

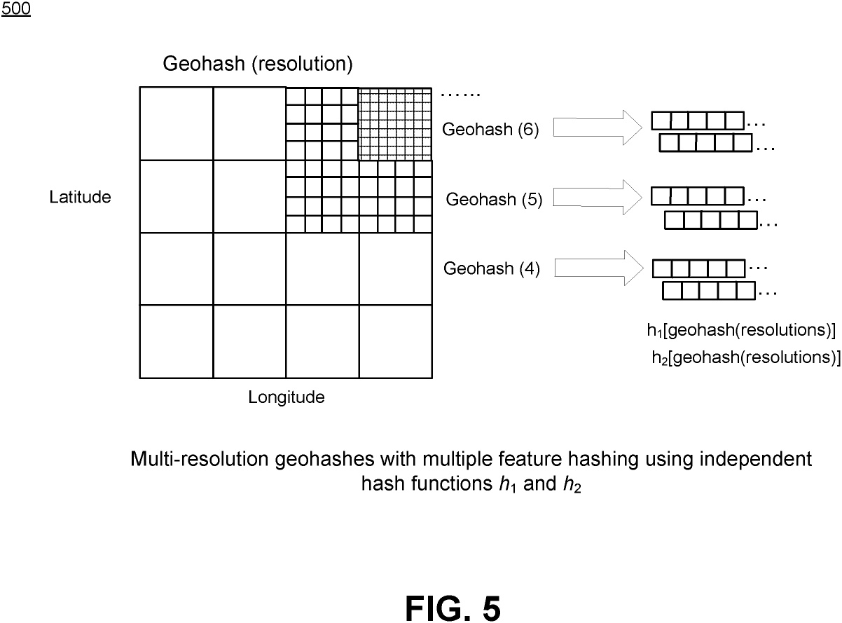

The operations of the embedding layer 310 performed on geospatial features 313 (in the non-limiting embodiment where geohashing is employed) are described in further detail below in connection with FIG. 5. FIG. 5 is an illustration 500 of multi-resolution geohashes with multiple feature hashing using independent hash functions, in accordance with some embodiments. Geospatial longitudes and latitudes are key features for ETA predictions. However, they are distributed very unevenly over the globe and contain information at multiple spatial resolutions. As shown in FIG. 5, the model may use geohasing to map locations to multiple different resolution grids based on latitudes and longitudes. As illustrated in FIG. 5, as the resolution increases, the number of distinct grid cells grows exponentially and the average amount of data in each grid cell decreases proportionally.

For example, the geohash function geohash lat, lng, u may be used to obtain a length u geohash string from a lat, lng pair. The geohash function is described below:
Map lat and lng into [0, 1] floats.
Scale the floats to [0, 2³²] and cast to 32 bit integers.
Interleave the 32-bits from lat and lng into one 64 bit integer.
Base32 encode the 64-bit integer and truncate to a string in which each character represents 5u bits.

After obtaining the encoded geohash (or locality-sensitive hashing-based) strings for each location, the embedding layer 310 performs feature hashing 430 to map the string to an index. In some embodiments, exact indexing may be performed to map these encoded geohash strings to indexes. This strategy maps each grid cell to a dedicated embedding. This takes up more space due to the exponential increase in cardinality with geohash precision. In other embodiments, the embedding layer 310 may perform multiple feature hashing 430 by mapping each grid cell to multiple ranges of bins using multiple independent hash functions, thus mitigating the effect of collisions when using only one hash.

In some embodiments, the geohash indexes of the begin and end location of an ETA request may be used separately, as well as together, as the geospatial features 313 for the machine-learned model 160. The algorithm for multiple feature hashing 430 is described below.

Taking a request that begins at o = (latₒlngₒ) and ends at d = (lat_{d}lng_{d}) as an example, the algorithm obtains two independent hash buckets each for the origin hₒ, destination h_{d}, and origin destination pair h_{od}. The independent hashing functions h₁(x) and h₂(x) may be defined as instances of MurmurHash3 with independent seeds. In addition, the algorithm may create geospatial features at multiple resolutions u ∈ {4, 5, 6, 7}. The motivation is that using a granular geohash grid will provide more accurate location information but suffer from more severe sparsity issues. Using multiple resolutions can help alleviate the sparsity issue.

The algorithm to map geospatial features to indexes has the following configuration:
Inputs: origin o, destination d, geohash resolution u
Outputs: independent hash bin pairs for origin hₒ, destination h_{d}, and origin - destination h_{od}
H(x) →(h₁(x)), (h₁(x))
H(geohash(o,u)) → hₒ
H(geohash(d,u)) → h_{d}
H(geohash(o,u)), geohash(d,u) → h_{od}

### Linear Self-Attention Layer

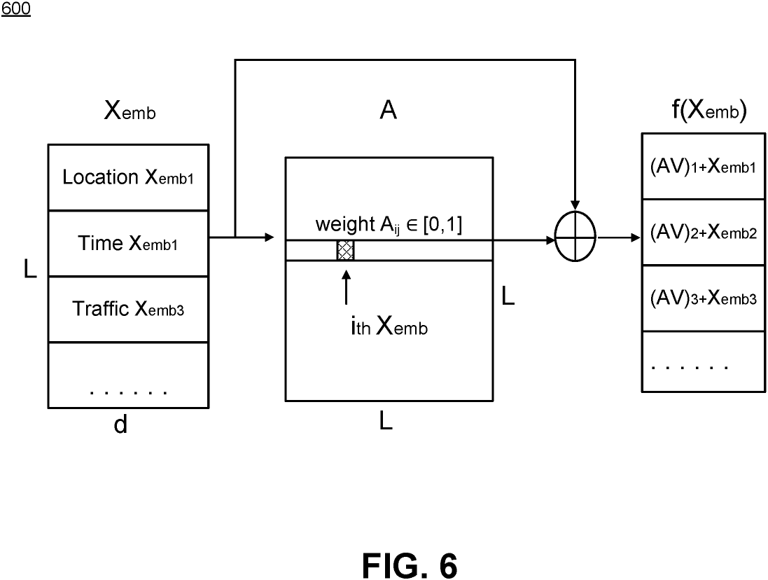

After transforming the features input to the model 160 into embeddings at the embedding layer 310 in FIG. 3, the embeddings are input to the linear self-attention layer 320. FIG. 6 is an illustration 600 of the sequence-to-sequence operation performed using an attention matrix of the linear self-attention layer 320, in accordance with some embodiments.

The linear self-attention layer 320 learns the feature interactions (e.g., interaction of spatial and temporal embeddings) via a sequence-to-sequence operation that takes in a sequence of vectors and produces a reweighted sequence of vectors. In some embodiments, the linear self-attention layer 320 may represent the features received from the embedding layer 310 such that each vector represents a single feature.

Self-attention uncovers pairwise interactions among L features by explicitly computing a L_{*}L attention matrix of pairwise dot products, using the softmax of these scaled dot-products to reweight the features. When the self-attention layer 320 processes each feature, it looks at every other feature in the input for clues and outputs the representation of this feature is a weighted sum of all features. Through this way, the self-attention layer 320 can bake the understanding of all the temporal and spatial features into the one feature currently being processed.

Taking a trip from an origin A to a destination B as an example, as illustrated in FIG. 6, the model inputs may be vectors of the time, the location, the traffic condition and the distance between A to B. The linear self-attention layer 320 takes in the inputs and scales the importance of the distance given the time, the location and the traffic condition.

For each ETA request, the feature embeddings are denoted as X_{emb} ∈ R^{L}*^{d} where L is the number of feature embeddings and d is the embedding dimension, L » d. The query, key and value in the self-attention is defined as

$$\begin{matrix}\text{Q} = {X}_{e m b} {W}_{q} , \\ \text{K} = {X}_{e m b} {W}_{k} , \\ \text{V} = {X}_{e m b} {W}_{v} ,\end{matrix}$$

where W_{q}, Wₖ, Wν ∈ R^{d}*^{d}. The attention is calculated as

$${A}_{i j} = \frac{exp {\left(Q {K}^{T} / \sqrt{d}\right)}_{i , j}}{{{\sum }_{j = 1}^{L} exp \left(Q {K}^{T} / \sqrt{d}\right)}_{i , j}}$$

where A ∈ R^{L}*^{L}. Then we use the attention matrix A to calculate the output of the interaction layer:

$$f \left({X}_{e m b}\right) = A V + {X}_{e m b} ,$$

using a residual structure. This interaction layer is illustrated in FIG. 6. In the case that the embedding dimension is not equal to the dimension of value V, a linear layer can be used to transform the shape.

The original self-attention described above has quadratic time complexity, because it computes a L × L attention matrix. To improve latency, the self-attention calculation may be linearized, for example, by implementing a linear transformer, linformer, performer, and the like. For example, to speed up the computation, the linear transformer may be applied in the linear self-attention layer 320. For the ith row of the weighted value matrix,

$$\begin{matrix}{{V}^{′}}_{i} = \frac{{\sum }_{j = 1}^{L} ϕ {\left({Q}_{i}\right)}^{T} ϕ \left({K}_{j}\right) {V}_{j}}{{\sum }_{j = 1}^{L} ϕ {\left({Q}_{i}\right)}^{T} ϕ \left({K}_{j}\right)} \\ = \frac{ϕ {\left({Q}_{i}\right)}^{T} {\sum }_{j = 1}^{L} ϕ \left({K}_{j}\right) {V}_{j}}{ϕ {\left({Q}_{i}\right)}^{T} {\sum }_{j = 1}^{L} ϕ \left({K}_{j}\right)}\end{matrix}$$

where the feature map ϕ(x) = elu(x) + 1 = max(a(e^{x} - 1), 0) + 1. Then the one linear iteration layer is

$$f \left({X}_{e m b}\right) = {V}^{′} + {X}_{e m b} ,$$

The computational cost of equation 9 is 0(L²d) and the cost of equation 11 is 0(Ld²), assuming the feature map has the same dimension as the value. When L » d, which is a common case for travel time estimation, the linear transformer is much faster.

### Calibration Layer

Returning to FIG. 3, the reweighted features output of linear self-attention layer 320 are input to the fully connected layer 330. And a residual output from the fully connected layer 330 is further calibrated using the calibration layer 340 that includes learned bias parameters for different calibration features 314.

The calibration features 314 convey different segments of the trip population such as whether the ETA request is for a pickup or a dropoff, for a long ride or a short ride, for a ride or a food delivery, and the like (e.g., type features). The calibration layer 340 may calibrate the residual predicted by the fully connected layer 330 based on, e.g., the request type. Finally, the calibrated residual 305 from the calibration layer 340 may be added to the RE-ETA 307 to output the refined ETA 309.

To address data heterogeneity, the embedding layer 310 of the machine-learned model 160 may embed request types for learning the interaction between the type features and other features via the linear self-attention layer 320. Further, in some embodiments, the machine-learned model 160 may implement the calibration layer 340 (e.g., segment bias adjustment layer) to address the data heterogeneity.

The calibration layer 340 may be a fully connected layer and have bias parameters for each request type (e.g., each calibration feature). Suppose bⱼ denotes the bias of the jth ETA request type, bⱼ is learned from a linear layer where the input is the one-hot encoded type features. Then, the residual 305 of the ithe request and jth type can be estimated as

$${\hat{r}}_{i j} = {\hat{f}}_{2} \left(\hat{f} \left({X}_{{i}_{\text{emb}}}\right)\right) + {\hat{b}}_{j} \left({X}_{{i}_{\text{type}}}\right)$$

where ƒ(▪) stands for the linear self-attention layer 320 and ƒ₂(▪) stands for a fully connected layer 330.

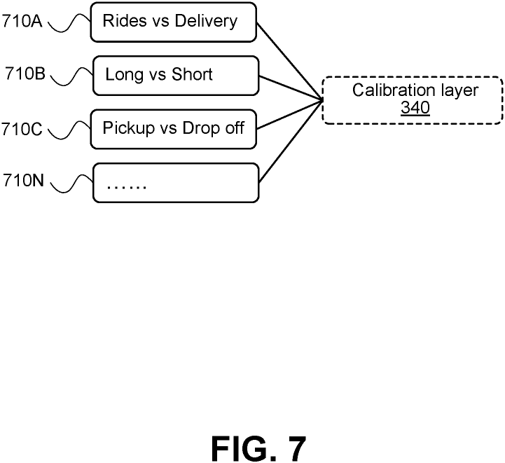

By implementing the calibration layer 340 the model 160 can adjust the raw prediction of the fully connected layer 330 by accounting for mean-shift differences across request types (e.g., different calibration features). FIG. 7 graphically illustrates how different calibration features or request types 710A-N may have different bias adjustment parameters and the calibration layer 340 may adjust the residual predicted by the fully connected layer 330 based on the bias adjustment parameters. The distribution of absolute errors varies significantly across delivery trips vs rides trips 710A, long vs short trips 710B, pick-up vs drop-off trips 710C, across global mega-regions, and the like. Adding bias adjustment layers to adjust the raw prediction for each of the different segments can account for their natural variations and in turn improve prediction accuracy with minimal latency increase.

### Model Training and Serving

Different use cases require different types of ETA point estimates and will also have varying proportions of outliers in their data. For example, a mean ETA may be estimated for fare computation while controlling for the effect of outliers. Other use cases may call for a specific quantile of the ETA distribution. To accommodate this diversity, the model may use a parameterized loss function, asymmetric Huber loss, which is robust to outliers and can support a range of commonly used point estimates. The asymmetric Huber loss in equation 14, which is robust to outliers and can balance a range of commonly used point estimates metrics.

$$L \left(δ , \text{Θ} ; \left(q , {y}_{0}\right) , y\right) = \left\{\begin{matrix}\frac{1}{2} {\left(y - \hat{y}\right)}^{2} , & \left|y - \hat{y}\right| < δ \\ δ \left|y - \hat{y}\right| - \frac{1}{2} {δ}^{2} & \left|y - \hat{y}\right| \geq δ\end{matrix}\right)$$

$$L \left(ω , δ , \text{Θ;} \left(q , {y}_{0}\right) , y\right) = \left\{\begin{matrix}ω L \left(δ , \text{Θ;} \left(q , {y}_{0}\right) , y\right) , & y < \hat{y} \\ \left(1 - ω\right) L \left(δ , \text{Θ;} \left(q , {y}_{0}\right) , y\right) , & y \geq \hat{y}\end{matrix}\right)$$

where ω ∈ [0, 1], δ > 0, Θ denotes the model parameters.

The loss function has two parameters, δ and ω, that control the degree of robustness to outliers and the degree of asymmetry respectively. By varying δ, squared error and absolute error can be smoothly interpolated, with the latter being less sensitive to outliers. By varying ω, we can control the relative cost of underprediction vs overprediction, which is useful in situations where being a minute late is worse than being a minute early in ETA predictions. These parameters not only make it possible to mimic other commonly used regression loss functions, but also make it possible to tailor the point estimate produced by the model to meet diverse goals.

### Example Process for Refining Predicted ETAs

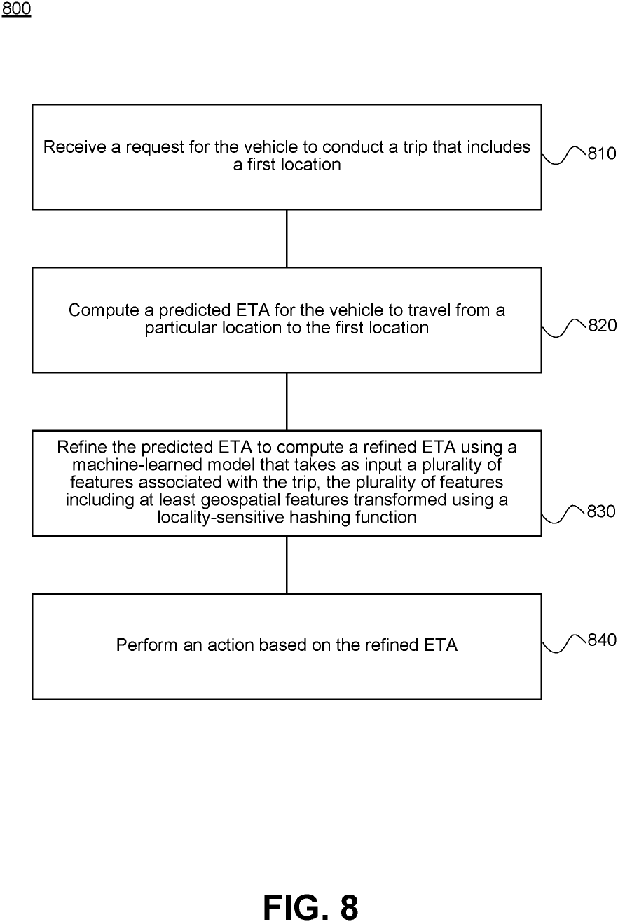

FIG. 8 is a flowchart depicting an example process 800 for refining predicted ETAs using the machine-learned model, in accordance with some embodiments. The process 800 may be performed by one or more components (e.g., routing engine 150, machine-learned model 160) of the server 130. The process 800 may be embodied as a software algorithm that may be stored as computer instructions that are executable by one or more processors. The instructions, when executed by the processors, cause the processors to perform various steps in the process 800. In various embodiments, the process 800 may include additional, fewer, or different steps.

The server 130 may receive 810 a request for a vehicle to conduct a trip that includes a first location (e.g., end location). For example, the routing API 170 of the server 130 may receive the request to compute the ETA from an ETA consumer (e.g., ride-sharing system, food delivery system, fare calculation system, system for matching riders to drivers, etc.) along with data (e.g., features) associated with the trip.

The routing engine 150 of the server 130 may compute 820 a predicted ETA (307 in FIG. 3) for the vehicle from a particular location (e.g., current location of the vehicle) to the first location. The server 130 may refine 830 the predicted ETA to compute a refined ETA (309 in FIG. 3) using the machine-learned model 160 that takes as input the plurality of features (in the embedding layer 310 of FIG. 3) associated with the trip, the plurality of features including geospatial features 313 transformed (at the embedding layer 310; FIGS. 3-4) using a locality-sensitive hashing function (425 in FIG. 4). The server 130 may perform 840 an action based on the refined ETA (309 in FIG. 3).

### Computer Architecture

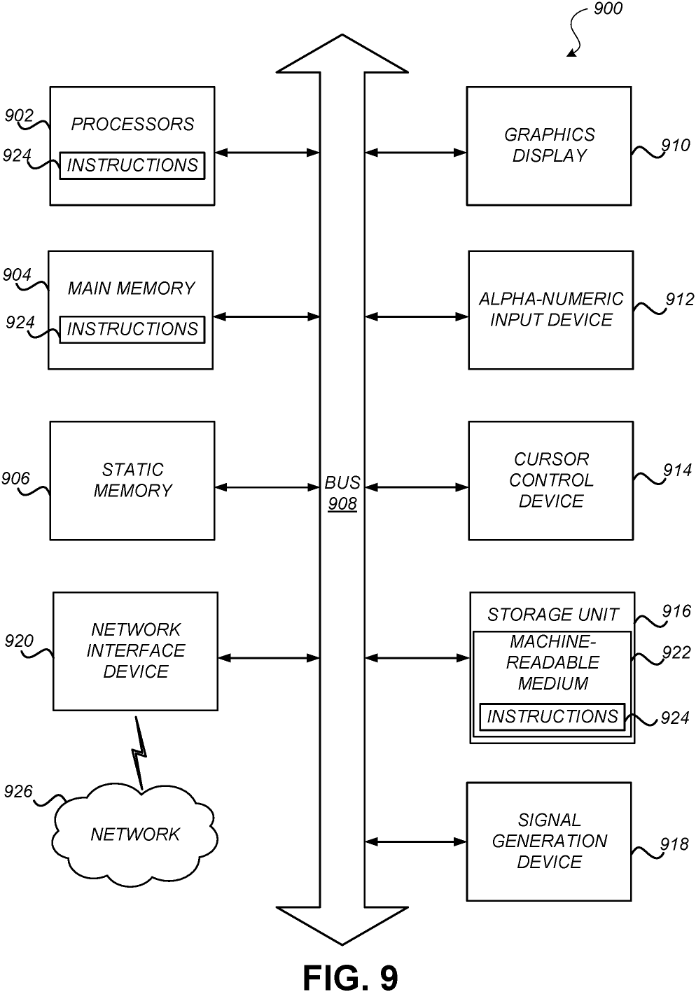

FIG. 9 is a block diagram illustrating components of an example computing machine that is capable of reading instructions from a computer-readable medium and execute them in a processor (or controller). A computer described herein may include a single computing machine shown in FIG. 9, a virtual machine, a distributed computing system that includes multiples nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, bytecode, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1, 3, 4, 7, and 8 including but not limited to, the server 130, routing engine 150, machine-learned model 160, method 800, and various layers, modules, and components shown in the figures. While FIG. 9 shows various hardware and software elements, each of the components described in figures may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the term “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 900 may also include a memory 904 that store computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 902 and reduces the space required for the memory 904. For example, the methods described herein reduce the complexity of the computation of the processors 902 by applying one or more novel techniques that simplify the steps in training, reaching convergence, and generating results of the processors 902. The algorithms described herein also reduces the size of the models and datasets to reduce the storage space requirement for memory 904.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processors 902, displays a GUI (GUI) to display one or more results and data generated by the processes described herein. The computer system 900 may also include an alphanumeric input device 912 (e.g., a keyboard), a cursor control device 914 (e.g., a mouse, a trackball, a joystick, a motion sensor, or another pointing instrument), a storage unit 916 (a hard drive, a solid state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor’s cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for predicting an estimated time of arrival (ETA) of a vehicle, the method comprising:
receiving a request for the vehicle to conduct a trip that includes a first location;
computing a predicted ETA for the vehicle to travel from a particular location to the first location;
refining the predicted ETA to compute a refined ETA using a machine-learned model that takes as input a plurality of features associated with the trip, the plurality of features including geospatial features transformed using a locality-sensitive hashing function; and
performing an action based on the refined ETA.

2. The method of claim 1, wherein the plurality of features further include continuous features, and wherein the method further comprises:
discretizing the continuous features into buckets; and
mapping the discretized continuous features to embeddings using the buckets.

3. The method of claim 1, wherein the locality-sensitive hashing function is a geohash function, and wherein the method further comprises:
transforming the geospatial features to generate geohash strings at different resolution grids based on a latitude and a longitude of the particular location and a latitude and a longitude of the first location; and
mapping the geohash strings to a unique index to look-up respective embeddings.

4. The method of claim 3, wherein mapping the geohash strings to the unique index comprises mapping each grid cell to multiple ranges of bins using multiple independent hash functions.

5. The method of claim 1, wherein the locality-sensitive hashing function hashes locations into buckets based on similarity.

6. The method of claim 1, further comprising inputting embeddings corresponding to the plurality of features into a self-attention layer of the machine-learned model to perform a sequence-to-sequence operation that takes in a sequence of vectors and produces a reweighted sequence of vectors.

7. The method of claim 6, wherein each vector of the sequence represents a single feature, and wherein the self-attention layer uncovers pairwise interactions among the plurality of features by computing an attention matrix of pairwise dot products and using the attention matrix to reweight the plurality of features.

8. The method of claim 6, wherein the plurality of features further include calibration features,
wherein the method further comprises calibrating a predicted residual, computed based on an output of the self-attention layer, using a calibration layer of the machine-learned model that includes learned bias parameters for different calibration features.

9. The method of claim 8, wherein the calibration features include at least one of a request type, a trip type, and a route type.

10. The method of claim 1, wherein computing the predicted ETA for the vehicle comprises: accessing map data and real-time traffic data;
using graph-based routing to identify a best path between the particular location and the first location based on the accessed data; and
computing the predicted ETA as a sum of segment-wise traversal times along the best path.

11. The method of claim 10, wherein the refined ETA is computed by adding a calibrated residual output of the machine-learned model to the predicted ETA computed using the graph-based routing.

12. The method of claim 1, wherein the machine-learned model is a self-attention-based deep learning model.

13. The method of claim 1, wherein the plurality of features further include temporal features including minute of day, and day of week, and wherein the geospatial features include a begin location, and an end location, wherein the particular location is the begin location and the first location is the end location.

14. The method of claim 1, wherein the plurality of features further include real-time speed, historical speed, estimated distances, the predicted ETA, and context information.

15. The method of claim 1, wherein the action comprises at least one of:
estimating a pickup time for the trip;
estimating a drop-off time for the trip;
matching a driver to the trip; and
planning a delivery.

16. A non-transitory computer-readable medium comprising instructions that, when executed by one or more processors, cause the one or more processors to perform operations comprising:
receiving a request for a vehicle to conduct a trip that includes a first location;
computing a predicted ETA for the vehicle to travel from a particular location to the first location;
refining the predicted ETA to compute a refined ETA using a machine-learned model that takes as input a plurality of features associated with the trip, the plurality of features including geospatial features transformed using a locality-sensitive hashing function; and
performing an action based on the refined ETA.

17. The non-transitory computer-readable medium of claim 16, wherein the locality-sensitive hashing function is a geohash function, and wherein instructions further cause the one or more processors to perform operations comprising:
transforming the geospatial features to generate geohash strings at different resolution grids based on a latitude and a longitude of the particular location and the first location; and
mapping the geohash strings to a unique index to look-up respective embeddings.

18. The non-transitory computer-readable medium of claim 16, wherein instructions further cause the one or more processors to perform an operation comprising inputting embeddings corresponding to the plurality of features into a self-attention layer of the machine-learned model to perform a sequence-to-sequence operation that takes in a sequence of vectors and produces a reweighted sequence of vectors.

19. The non-transitory computer-readable medium of claim 16, wherein the locality-sensitive hashing function hashes locations into buckets based on similarity.

20. A system comprising:
one or more processors; and
memory operatively coupled to the one or more processors, the memory comprising instructions that, when executed by the one or more processors, cause the one or more processors to:
receive a request for a vehicle to conduct a trip that includes a first location;
compute a predicted ETA for the vehicle to travel from a particular location to the first location;
refine the predicted ETA to compute a refined ETA using a machine-learned model that takes as input a plurality of features associated with the trip, the plurality of features including at least geospatial features transformed using a locality-sensitive hashing function; and
perform an action based on the refined ETA.
